(19) United States
(12) Patent Application Publication
(10) Pub. No.: US 2011/0182542 A1
(43) Pub. Date: Jul. 28, 2011

(54) THRUST NEEDLE ROLLER BEARING WITH ISOLATING LAYER

(75) Inventors: James BROWN, ROCK HILL, SC (US); Eric CLARK, ROCK HILL, SC (US); Joseph GRIFFIN, MATTHEWS, NC (US)

(73) Assignee: SCHAEFFLER KG, Herzogenaurach (DE)

(21) Appl. No.: 12/695,568

(22) Filed: Jan. 28, 2010

(51) Int. Cl. F16C 33/34

(52) U.S. Cl. 384/620

(57) ABSTRACT

A thrust needle bearing with an isolating layer has a cage with rollers, washers on which the rollers run, at least one of the washers is attached to the cage, backup surfaces fixed external to each of the washers and an isolating layer attached to at least one of the washers, which is interposed between the at least one of the washers and at least one of the backup surfaces of the bearing. The isolating layer is a layer of vibration-attenuating material. Alternatively, the isolating layer is a layer of material which has properties that prevent creep or sliding wear for at least one of the backup surfaces. The isolating layer is attached to the washers by bonding, use of adhesives or mechanical means.

### FIELD OF INVENTION

The present invention relates to thrust bearings. More particularly, the present invention relates to a thrust needle bearing assembly that has at least one layer of vibration-attenuating or wear-reducing material.

### BACKGROUND OF THE INVENTION

Thrust needle bearings are used in transmissions, torque converters, and transfer cases to transfer thrust loads between adjacent components that operate with relative rotational speed. Thrust needle bearings allow the relative speed to occur with low friction. Typically, thrust bearings include a cage, which contains rollers, and washers on which the rollers run with the area of each washer contacting the rollers being a raceway. For convenience of assembly, one or both washers can be attached to the cage in a manner that allows free rotation for bearing function. Alternatively, one or both washers can be separate from the cage.

When the bearing is operating under load and speed, imperfections in the roller roundness and on the raceway surface, or contamination present in the bearing, will create vibrations that are transmitted through the washers to the bearing's surfaces. If the vibrations are of sufficient amplitude and in critical frequency ranges and if there is a free path for the vibration to the surface of the case, the result is objectionable noise. When the bearing is under load it can transmit vibrations from other sources. Rotation or creep of the bearing washers against their backup surfaces may cause unacceptable wear of those surfaces.

Certain thrust bearings can result in perceived noise due to vibrations transmitted through the interface between the thrust bearing and its backup surface. Additionally, excessive wear of the bearing's backup surface can occur due to relative motion.

U.S. Pat. No. 4,883,374, for example, discloses a thrust bearing. Such a thrust bearing assembly includes a cage containing rollers, two washers and a plastic annular spacer affixed to a washer. The spacer is available in a range of predetermined thicknesses and is used solely for clearance control of the thrust bearing. The thickness of the spacer is determined based on the axial clearance in a transmission assembly.

Additionally, U.S. Pat. No. 5,110,223, for example, discloses a thrust bearing. Such a thrust bearing assembly includes a cage containing rollers, two washers, and a spacer. The spacer is available in a range of predetermined thicknesses and is used to provide axial clearance in a transmission assembly. The spacer is also aids in providing frictional retention of the bearing on a shaft or within a bore.

Moreover, U.S. Pat. No. 5,233,913, for example, discloses a thrust bearing. Such a thrust bearing assembly includes a cage containing rollers, two washers, and a central body that has o-rings. Here, the washers, which are spring washers, are used to preload the thrust bearings to compensate for tolerance clearance and wear, and to absorb axial shock loading in a swash plate compressor shaft. The o-rings are placed between the thrust bearing and the shaft to damp vibrations.

Furthermore, U.S. Pat. No. 3,934,956, for example, discloses an axial thrust bearing. Such a thrust bearing utilizes one or more layers of elastically yieldable material, or alternatively, a spring, to control axial clearance or preload due to tolerances and thermal expansion and also to accommodate misalignment.

U.S. Pat. No. 3,093,427, for example, discloses disclose a ball or roller bearing that has running rings. At least one of the running rings has damping elements arranged on both sides of the running ring(s). The damping elements are intended to prevent failure and to improve damping.

Finally, U.S. Pat. No. 3,447,846, for example, discloses a bearing assembly with a layer or resilient material positioned between the outer ring of a radial bearing and an outer supporting member. The resilient layer attenuates vibration transmitted to the outer supporting member. The layer also accommodates some axial movement of the shaft and allows radial clearance to be maintained in spite of expansion or shrinking of the outer supporting member due to changes in temperature.

### SUMMARY OF THE INVENTION

The present invention is directed to a thrust needle roller bearing having an isolating layer. The thrust bearing includes: a cage, which contains rollers, washers on which the rollers run with the area of each washer contacting the rollers being a raceway, at least one isolating layer, and backup surfaces. For convenience of assembly, one or both washers can be attached to the cage in a manner that allows free rotation for bearing function. Alternatively, one or both washers can be separate from the cage. The isolating layer is arranged between the external face(s) of the washers and the backup surfaces which are positioned on each side of the thrust bearing. The isolating layer can be attached to at least one of the washers.

The isolating layer can act in a variety of capacities and can be comprised of various materials. The isolating layer can also be a layer of vibration-attenuating material, which reduces noise due to vibrations transmitted between the thrust bearing and the backup surfaces. Moreover, the isolating layer can be a layer of material with properties that prevent creep or sliding wear of the backup surfaces. The isolating layer is attachable to at least one of the washers by bonding, adhesive means, or mechanical means. Furthermore, the isolating layer must have adequate material properties and an adequate thickness to provide useful vibration attenuation or wear-reduction and must be able to withstand the operating environment (temperature, chemical, pressure, time) without unacceptable loss of attenuating or other physical properties, and without the compliant layer experiencing unacceptable wear.

Broadly, the present invention can be defined as follows: a thrust needle roller bearing, including: a cage having rollers; two washers on which the rollers run, at least one of the washers being attached to the cage, allowing free rotation for bearing function; backup surfaces fixed external to each of the washers; and an isolating layer attached to at least one of the washers. The isolating layer is interposed between at least one of the washers and the associated backup surface.

In one embodiment, the isolating layer can be a layer of vibration-attenuating material.

In another embodiment, the isolating layer can be a layer of material having properties that prevent creep or sliding wear of the backup surface.

In yet another embodiment, the isolating layer is attached to the at least one washer by bonding, use of adhesives or mechanical means.

In a further embodiment, the isolating layer incorporates a plurality of interfaces, each attenuating vibration.

Still another embodiment provides that the backup surfaces incorporate an attenuation layer.

Moreover, in another embodiment, the isolating layer is an attenuation layer, which breaks up a free vibration path from the backup surfaces to an acoustic radiator.

In yet a further embodiment, the isolating layer includes a gap that breaks up a free vibration path from the backup surfaces to an acoustic radiator.

### BRIEF DESCRIPTION OF THE DRAWINGS

The present invention will be further understood and appreciated by reading the following description in conjunction with the accompanying drawings, in which:

FIG. 1 is a cross-sectional view illustrating the thrust needle roller bearing with an isolating layer;

FIG. 2 is an end view illustrating the isolating layer attached to a washer; and

FIG. 3 is a cross-sectional view illustrating the thrust needle roller bearing with an isolating layer and backup surfaces.

### DETAILED DESCRIPTION OF THE INVENTION

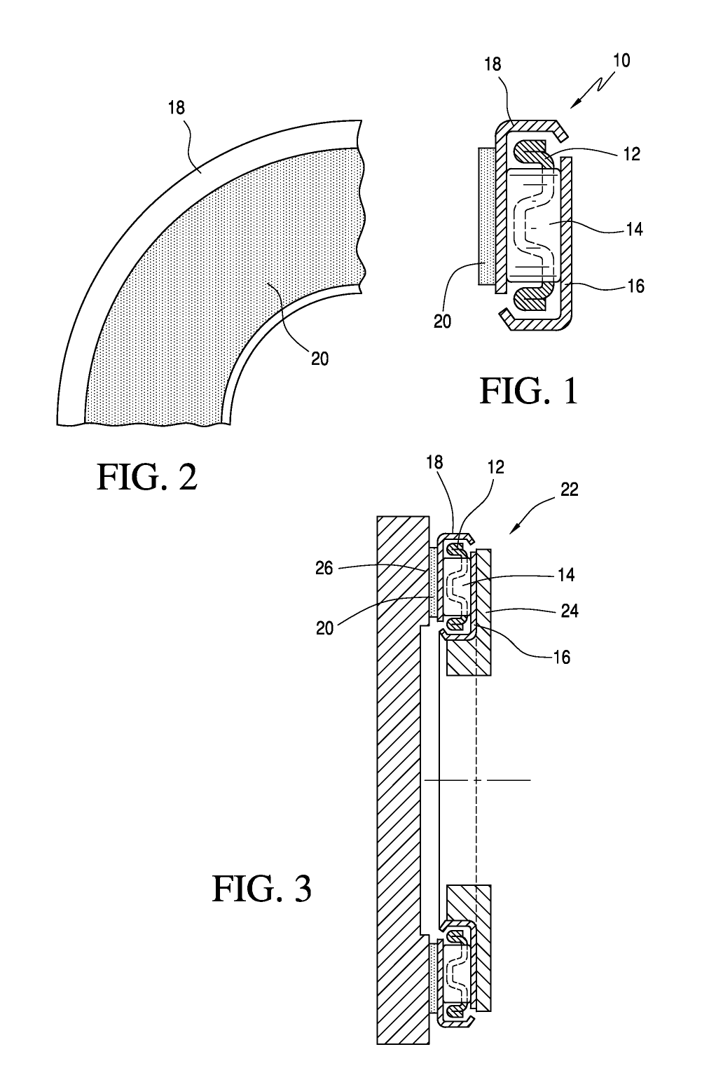

Referring now to the drawings, in which like reference numerals refer to like reference parts throughout, FIG. 1 shows a cross-sectional view of the thrust needle roller bearing 10. The thrust needle roller bearing 10 includes a cage 12 which contains rollers 14. Washers 16, 18, on which the rollers 14 roll, are attached on each side of the cage 12. An isolating layer 20 is interposed between at least one of the washers 16, 18 and a backup surface 24, 26 (see FIG. 3) of the bearing 10.

The isolating layer 20 can be a layer of vibration-attenuating material, which reduces noise due to vibrations transmitted between the thrust bearing 10 and the backup surfaces 24, 26 (see FIG. 3). Moreover, the isolating layer 20 can be a layer of material with properties that prevent creep or sliding wear of the backup surfaces 24, 26 (see FIG. 3). The isolating layer 20 is attachable to at least one of the washers 16, 18 by bonding, adhesive means, or mechanical means. The isolating layer 20 must have adequate material properties and an adequate thickness to provide useful vibration attenuation or wear-reduction. Additionally, the isolating layer 20 must be able to withstand the operating environment (temperature, chemical, pressure, time) without unacceptable loss of attenuating or other physical properties, and without the isolating layer 20 experiencing unacceptable wear.

FIG. 2 shows an end of the isolating layer 20 attached to one of the washers 18.

FIG. 3 shows a cross-sectional view illustrating the thrust bearing 10 with the isolating layer 20 and the backup surfaces 24, 26. The isolating layer 20 associated with the thrust bearing 10 is made from a vibration-attenuating material, wear-reducing material, or properties that prevent creep or sliding wear of the backup surfaces 24, 26, depending on whether the back-up surfaces 24, 26 are wear sensitive or noise sensitive. As shown, the isolating layer 20 is interposed between the thrust bearing 10 and the backup surface 26, and is affixed to one of the washers 18. The backup surface 24 contacts the washer 16, which does not have an isolating layer 20.

The present invention has been described with reference to a preferred embodiment. It should be understood that the scope of the present invention is defined by the claims and is not intended to be limited to the specific embodiment disclosed herein.

What is claimed:

1. A thrust needle roller bearing, comprising:
a cage having rollers;
two washers on which the rollers run, at least one of the washers being attached to the cage, allowing free rotation for bearing function;
backup surfaces fixed external to each of the washers; and
an isolating layer attached to at least one of the washers,
the isolating layer being interposed between the at least one of the washers and the associated backup surface.

2. The thrust needle roller bearing of claim 1, wherein the isolating layer is a layer of vibration-attenuating material.

3. The thrust needle roller bearing of claim 1, wherein the isolating layer is a layer of material having properties that prevent creep or sliding wear of the backup surface.

4. The thrust needle roller bearing of claim 1, wherein the isolating layer is attached to the at least one washer by bonding, adhesives or mechanical means.

5. The thrust needle roller bearing of claim 1, wherein the isolating layer incorporates a plurality of interfaces, each attenuating vibration.

6. The thrust needle roller bearing of claim 1, wherein the backup surfaces incorporate an attenuation layer.

7. The thrust needle roller bearing of claim 1, wherein the isolating layer is an attenuation layer.

8. The thrust needle roller bearing of claim 9, wherein the attenuation layer breaks up a free vibration path from the backup surfaces to an acoustic radiator.

9. The thrust needle roller bearing of claim 1, wherein the isolating layer includes a gap that breaks up a free vibration path from the backup surfaces to an acoustic radiator.
